(19) United States
(12) Patent Application Publication
(10) Pub. No.: US 2006/0036583 A1
(43) Pub. Date: Feb. 16, 2006

(54) Systems and methods for processing search results

(76) Inventors: Laust Sondergaard, Palo Alto, CA (US); Anders Hyldahl, Virum (DK)

Correspondence Address: TRAN & ASSOCIATES, 6768 MEADOW VISTA CT., SAN JOSE, CA, 95135, US

(21) Appl. No.: 10/919,854

(22) Filed: Aug. 16, 2004

(51) Int. Cl. G06F 17/30

(52) U.S. Cl. 707/3

(57) ABSTRACT

Systems and methods are disclosed for retrieving on-line information by receiving a request for a document from an information system; parsing the request for a source identifier; searching for documents in a local search system in response to the parsed request; and providing one or more responsive documents to the request.

The Internet has become a significant medium for communication and commerce and has enabled millions of people to share information and conduct business electronically. The unique characteristics of the Internet, such as its ability to provide enhanced communication, rich text, and graphic environment, provide ideal support for a wide variety of electronic commerce transactions. For example, a consumer can search, review, and extensively shop on a number of competing chains in an instant. As such, consumers benefit by being able to obtain a good price relatively quickly and easily.

On-line retailers also benefit, since these retailers can carry a larger number of products at a lower cost and with greater merchandising flexibility without the physical constraints faced by traditional retailers. Additionally, they can assist the consumer's purchase decision by providing relevant information and enabling consumers to shop at their convenience by remaining open twenty-four hours a day, seven days a week. Online retailers can also provide personalized services and use direct marketing efforts based on information provided by customers.

To help users navigate the complexity of the web in gathering information for purchase decision making, users typically enter search words into a search engine such as engines from Google, Yahoo, MSN, or AskJeeves, among others. These engines typically provide search benefits for free, and they rely on advertising fees for revenue generation. For advertisers, Internet advertising is a way of getting a company's website listed at the top of the search results or in a featured area for a fee. This fee is usually a fixed fee per click or a fee that is bid against other competitors in an auction. “Paid” or “Featured” placements are given a higher priority than non-paid or traditional spidered search engine results.

For instance, Google's AdWords advertisements connect advertisers with prospective customers at the precise moment when they are looking for products or services. The advertiser creates an advertisement, chooses keywords to help the search engine match the advertisement to the audience and pays only when someone clicks on the advertisement. Preferably, when the user selects or clicks on an advertisement, the user is directed to a page called a landing page that contains carefully crafted information for prospective purchasers. For Google Web search, Google Groups, and the Google Directory, the ads appear along side or above the results on Google search results pages. The Google ads for a particular advertiser can also appear with the search results that link or point to various pages from the advertiser's web site.

FIG. 1 illustrates an exemplary search using Google with the term “mondosoft.” On the left side, a series of search results including URL links and a brief descriptive text is provided for each search result matching the query “mondosoft.” On the right side, a series of advertisements or sponsored links are provided.

Since users tend to rely on the search results more than on the advertisements, they often try the links provided by the search results. However, over time, some links may be broken and the user may have to do another search to locate the desired information. For marketing purposes, the ability to ensure that customers are directed to designated pages matching the user's search query is crucial. However, since many users ignore the ads and click on the search results, it is important for a company to control access to its web-site from a search engine so that only current and valid pages are returned when the user clicks on a search result link or pointer.

### SUMMARY

Systems and methods are disclosed for retrieving on-line information by receiving a request for a document from an information system; parsing the request for a source identifier; searching for documents in a local search system in response to the parsed request; and providing one or more responses to the request from the information system.

Implementations of the above aspect may include one or more of the following. The source identifier can be a referrer for the request. The searching operation can include performing a search based on the referrer source, a search term, previous user behavior for said search term, behavior from a plurality of users, user profile, date and time, or a derived search term. The derived search term can be done using one of: fuzzy logic, business logic, predictive analytics, and statistical clustering. The searching operation can also be based on the languages requested by the user, the nationality the user, or the resource requested by the user. The information system can be a database, an intranet, a global search system, or a product comparison website. The document request can be a link from a remote server such as an intranet or an extranet. The responsive document can be a landing page. The landing page may be either a different page than the user originally requested—or the same (dynamic) page, with an additional marking that can be interpreted by the logic used to present the page—such that particular information appears or does not appear on the page.

Advantages of the system can include one or more of the following. All documents an advertiser or company intends to present will be presented in a desired order, design, and categorization, among others. By accurately and conveniently providing information to a prospective customer, the system enables the company to market the functionality, to brand it, and to gain competitive advantages over competitors. The system allows site publishers, who know their content best, to tune the search engine to fit in with the context of their site. The system interprets questions (queries) as they are most likely to arrive (speak the users' language). The system gives help when necessary, to establish a common context between the users and the site (e.g., present results in categories; give spelling, grammar and/or synonym suggestions). Additionally, the system presents search results in a context easily recognizable to the user.

The insertion of the system between the remote information system and the company's web site allows content to be intelligently targeted to the user's search request. Thus, if the link from the remote information system to the company's page is invalid, the system can automatically redirect the user to a desired landing page or any suitable page the provides the user with information that the company wishes the user to view such as targeted marketing information or educational material, for example.

Other advantages may include one or more of the follow. The system provides a supplier with the ability to help customers find goods and services offered on-line. Additionally, the system provides an accurate view of the behavior of buyers and their product demands, enabling a quick response to rapid shifts in customer needs. The system also transforms customer interest data into actionable knowledge of customer behavior and preferences.

### BRIEF DESCRIPTION OF THE DRAWINGS

The foregoing and other objects, features and advantages of the present invention will be apparent from the following detailed description of the preferred embodiments of the invention, reference being made to the accompanying drawing, in which like reference numerals indicate like parts and in which:

FIG. 1 shows a prior art search screen.

FIG. 2 shows an exemplary search system.

FIG. 3 shows an exemplary embodiment of an information manager module.

FIG. 4 shows an architectural view of a system with the information manager module.

FIG. 5 shows an exemplary process to respond to a page request from a referrer.

FIG. 6 shows an operation in FIG. 5 in more detail.

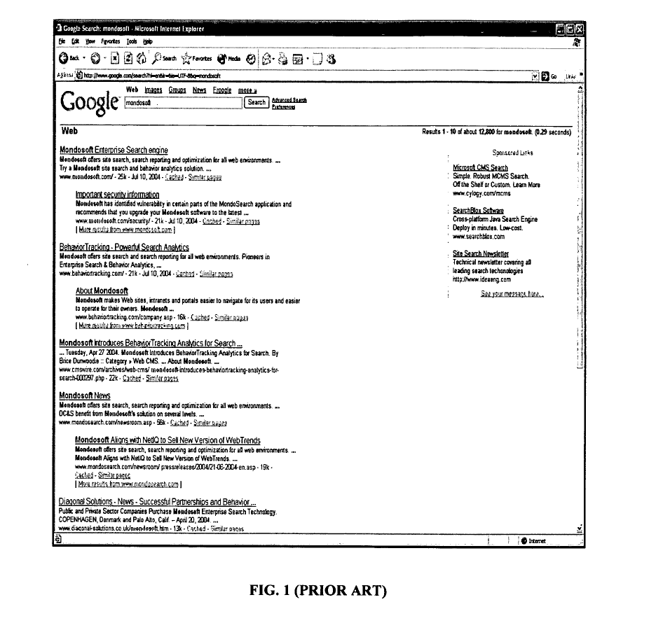

### DESCRIPTION

Although the following detailed description contains many specifics for the purposes of illustration, anyone of ordinary skill in the art will appreciate that many variations and alterations to the following details are within the scope of the invention. Accordingly, the following preferred embodiment of the invention is set forth without any loss of generality to, and without imposing limitations upon, the claimed invention.

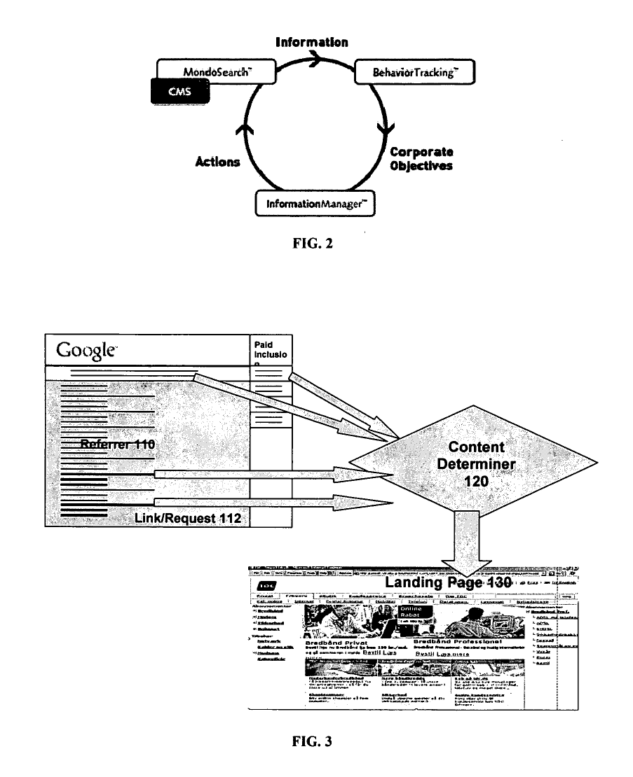

FIG. 2 shows an exemplary system that enables enterprises to perform effective online dialog with customers over the Internet. The system works with content management systems and is based on three interoperating modules which provide a high degree of synergy with each other and help make information a more valuable asset. The interoperating modules include a search module 10, a behavior tracking module 20, and an information manager module 30.

The search module 10 provides an overview of information to end-users, as well as to site owners through the behavior tracking module 20. Behavior tracking makes it easy to see how content could be improved and how products, services or information should target user needs. The actions are applied and aligned to corporate strategies with the information manager module 30.

In one embodiment, the search module 10 is MondoSearch™, a multi-lingual enterprise search engine from Mondosoft of Palo Alto, Calif. MondoSearch delivers categorized search results in context, so users will know what is relevant to them. The behavior tracking module 20 can be Mondosoft's BehaviorTracking™ which provides information to improve response quality and thereby business results. BehaviorTracking makes MondoSearch smarter with every visit because it tracks each search all the way through to its successful—or unsuccessful—conclusion and learns from visitors' behavior. The behavior tracking module 20 provides reports-on-demand that recommend what actions should be taken to improve sales, cut costs and retain customers, for example.

The information manager module 30 can be Mondosoft's InformationManager™ which dynamically manages information and content on a site owner's website, and MondoSearch, which represents a site's tool for interacting with users. InformationManager makes it easy to put the insight obtained via BehaviorTracking into tangible actions and improvements that provide users a great experience.

During operation, the search module 10 records data about the searches while serving the search requests. It then sends the recorded data to the behavior tracking module 20 that analyzes for interests, trends and needs, and feed the information to the site administrators, editors, marketing and management. The knowledge of user interests and behavior—arising from behavior tracking can be evaluated on a real-time basis and allow for constant refinement and recalibration of content to insure up-to-date and relevant information that meets visitor expectations. The information manager module 30 enables users to apply the knowledge obtained from the behavior tracking module 20 to improve the site usability and search success.

FIG. 3 shows an exemplary embodiment of an information manager module 30. When the user clicks on a link from the search engine, the search engine as a referrer sends a request to the company's web site. In one embodiment, the information manager module 30 receives a request 112 from an information system or referrer 110 such as a search engine, price comparison website or product reviewers including newspapers and magazines. Example sites are Teoma, Google, Yahoo, MSN, PriceGrabber, Ebay, Kelkoo, Epinions etc. Additionally, the information system, referrer or site can include comparison sites, portals, or a site owner's own intranet. Searching is to be understood in the present context as, at least, the process of finding matches between words in a search query and text stored in a database, or the process of interactively stepping through different levels of menus, intentionally, leading to a document meeting the search query. The last search example is for instance known in systems in which documents on a web-site are accessible in a directory structure manner and wherein a specific document is found by stepping through different levels of directories. In the present context the terms web-pages and web-sites should be given their broadest possible meaning. Furthermore and additionally, a web-page is to be considered as a data item, being accessible by HTTP for instance, and a web-site is to be considered as a collection of data items, such as for instance NEWS. In this light, the terms web-pages and web-sites should not be construed based solely on the present meaning of these terms.

The request 112 is processed by a content determiner 120. The content determiner 120 decides the best document that matches the request, in this case a landing page 130 and serves the landing page 130 as a response to the request 112. The landing page 130 can be determined by the behavior on the global search (i.e.) the search term used, profiling from CRM, previous user behavior, among others.

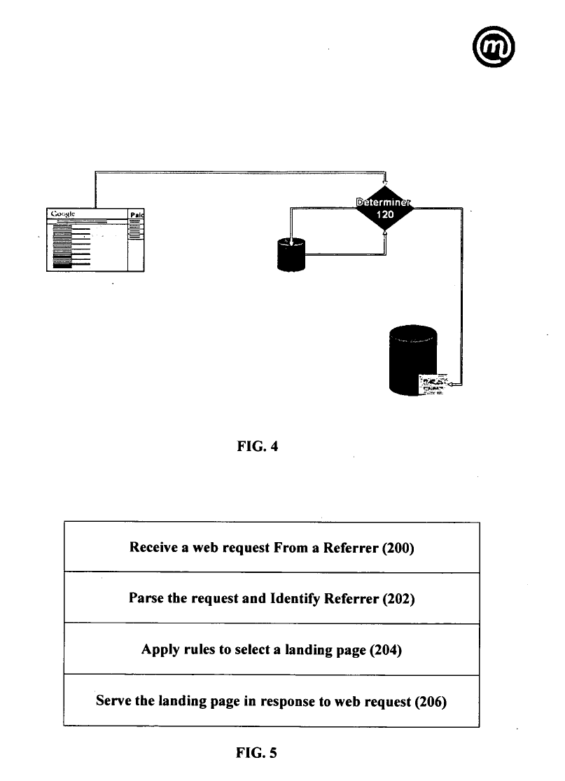

FIG. 4 shows an architectural view of a system with the information manager module. In FIG. 4, a user performs a search at a web site of the referrer 110 such as a search engine. Users can quickly evaluate the success of their query by checking a summary of the overall results. This should include a quick overview of how many pages were found, which search words were not found, which languages were found, among others. The summary can contain unique titles and descriptions for found pages based on page content.

The user clicks on a search result and is taken to a particular web page. The link or request 112 which includes referral source information is sent to the determiner 120. The determiner 120 looks up data in a business logic database (BLD) 150. The database 150 can be a relational database. Based on the result found in the BLD, the determiner 120 provides a link to a page that is responsive to the user's search. The page is part of a web site hosted by a company's server 160. Typically, the referrer's server is not under the control of the company's server 160. The insertion of the determiner 120 between the referrer 110's web site and the company's web site allows content to be intelligently targeted to the user's search request. Thus, if the link from the information system to the company's page is invalid, the determiner 120 can automatically redirect the user to a desired landing page or any suitable page the provides the user with information that the company wishes the user to view such as targeted marketing information or educational material, for example.

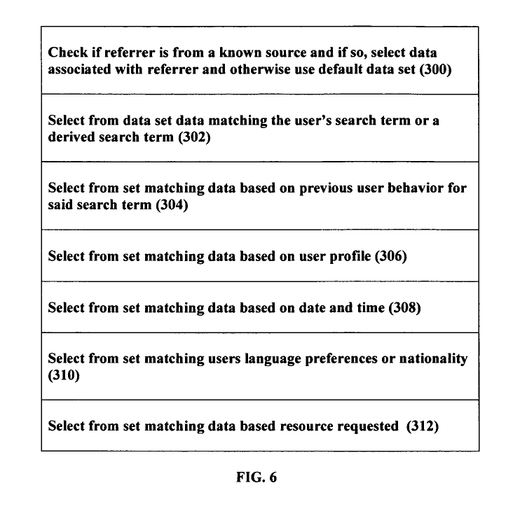

FIG. 5 shows an exemplary process to respond to a page request from a referrer. In this embodiment, the referrer is a search engine as discussed above. The process receives a web request with information about the referrer (200). The received request can conform to the HTTP standard and includes a referrer identification embedded in the request. The process parses the request and identifies the referrer (202). Based on the search request, the referrer identification, document requested, date, time of day, previous requests from the same user, nationality, languages, user identification, cookies or other information available in the request, the process applies one or more rules to a database to search for a predetermined page most responsive to the user's query (204). The responsive page can be a landing page, among others. The process then serves or redirects to the landing page to the user in response to web request from the referrer (206).

The landing page may be either a different page than the user originally requested—or the same (dynamic) page, with an additional marking that can be interpreted by the logic used to present the page—such that particular information appears or does not appear on the page.

FIG. 6 shows one embodiment of operation 204. First, the process checks if the referrer is from a known source and if so, selects data associated with referrer and otherwise the process uses a default data set (300). For example, if the search came from Google, a set of data optimized for responding to requests from Google is selected. Next, the process selects from the prior data set data matching the user's search term or from a derived search term such as the search term clustering (302), for example. Clustering is a particular statistical analysis method, but other analytics methods could be applied as well; the derived search term could be derived from fizzy logic, business logic, predictive analytics, and statistical clustering, among others.

The process can then select from the data set matching data based on previous user behavior for said search term (304). Thus, if a number of prior searches indicate that a particular page is responsive, that page will be selected. Additionally, the process selects from the data set matching data based on user profile (306). Thus, if the user indicates that he or she is from a particular industry, the data set can be narrowed to the specific industry, for example. The process can also select from the data set matching data based on date and time (308). Additionally, the process can select from sets that match the nationality of the request or the language(s) of the request (310). Finally the original resource the user requested is also considered (312).

The invention has been described in terms of specific examples which are illustrative only and are not to be construed as limiting. The invention may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

From the aforegoing disclosure and certain variations and modifications already disclosed therein for purposes of illustration, it will be evident to one skilled in the relevant art that the present inventive concept can be embodied in forms different from those described and it will be understood that the invention is intended to extend to such further variations. While the preferred forms of the invention have been shown in the drawings and described herein, the invention should not be construed as limited to the specific forms shown and described since variations of the preferred forms will be apparent to those skilled in the art. Thus the scope of the invention is defined by the following claims and their equivalents.

While this invention has been particularly shown and described with references to preferred embodiments thereof, it will be understood by those skilled in the art that various changes in form and-details may be made therein without departing from the spirit and scope of the invention as defined by the appended claims.

1. A method for retrieving on-line information, comprising:
receiving a request for a document linked from a remote information system;
parsing the request for a source identifier;
searching for documents in a local search system in response to the parsed request; and
providing one or more responsive documents to the request from the remote information system based on a local search.

2. The method of claim 1, wherein the source identifier comprises a referrer for the request.

3. The method of claim 2, wherein the searching further comprises performing a search based on a referrer identifier.

4. The method of claim 1, wherein the searching further comprises performing a search based on a search term.

5. The method of claim 1, wherein the searching further comprises performing a search based on previous user behavior for said search term.

6. The method of claim 5, wherein the previous user behavior comprises behavior from a plurality of users.

7. The method of claim 1, wherein the searching further comprises performing a search based on a user profile.

8. The method of claim 1, wherein the searching further comprises performing a search based on date and time.

9. The method of claim 1, wherein the searching further comprises performing a search based on a derived search term.

10. The method of claim 9, wherein the derived search term is searched using one of:
fuzzy logic, business logic, predictive analytics, and statistical clustering.

11. The method of claim 1, wherein the searching further comprises performing a search based on one or more languages requested by a user.

12. The method of claim 1, wherein the searching further comprises performing a search based on a user nationality.

13. The method of claim 1, wherein the searching further comprises performing a search based on a resource requested by a user.

14. The method of claim 1, wherein the remote information system comprises one of:
a database, an intranet, and a global search system.

15. The method of claim 1, wherein the third-party database comprises a product comparison website.

16. A system for retrieving information, comprising:
means for receiving a request for a document from a remote information system;
means for parsing the request for a source identifier;
means for locally searching for documents in response to the parsed request; and
means for providing one or more responsive documents to the request from the remote information system.

17. The system of claim 16, wherein the source identifier comprises a referrer for the request.

18. The system of claim 17, wherein the searching further comprises means for performing a search based on the referrer.

19. The system of claim 16, wherein the searching further comprises means for performing a search based on a search term.

20. The system of claim 16, wherein the searching further comprises means for performing a search based on previous user behavior for said search term.

21. The system of claim 20, wherein the previous user behavior comprises behavior from a plurality of users.

22. The system of claim 16, wherein the searching further comprises means for performing a search based on a user profile.

23. The system of claim 16, wherein the searching further comprises means for performing a search based on date and time.

24. The system of claim 16, wherein the searching further comprises means for performing a search based on a derived search term.

25. The system of claim 24, wherein the derived search term is searched using one of:
fuzzy logic, business logic, predictive analytics, and statistical clustering.

26. The system of claim 16, wherein the searching further comprises performing a search based on the languages requested by a user.

27. The system of claim 16, wherein the searching further comprises performing a search based on a user nationality.

28. The system of claim 16, wherein the searching further comprises performing a search based on a resource requested by a user.

29. The system of claim 16, wherein the document request comprises a link from one of: a database, an intranet, a global search system and a product comparison website.

30. The system of claim 16, wherein the document request comprises a link from a remote server.

31. The system of claim 30, wherein the server is an intranet or an extranet.

32. The system of claim 16, wherein the responsive document comprises a landing page.

33. The system of claim 32, wherein the landing page comprises a different page than the originally requested document.

34. The system of claim 32, wherein the landing page comprises a dynamic page.

35. The system of claim 32, wherein the landing page comprises marking information interpretable by a renderer of the page.

36. The system of claim 35, wherein the marking information appears on the page.

37. The system of claim 35, wherein the marking information is invisible on the page.
